(19) United States
(12) Patent Application Publication
(10) Pub. No.: US 2010/0287402 A1
(43) Pub. Date: Nov. 11, 2010

(54) TIMESTAMPING APPARATUS AND METHOD

(75) Inventors: Seung-Hwan KIM, Daejeon-si (KR); Kwang-Joon Kim, Daejeon-si (KR); June-Koo Rhee, Daejeon-si (KR); Kyu-Sang Lee, Seoul (KR); Chan-Kyun Lee, Daejeon-si (KR); Seong-Jin Lim, Chungcheongbuk-do (KR)

Correspondence Address: STAAS & HALSEY LLP, SUITE 700, 1201 NEW YORK AVENUE, N.W., WASHINGTON, DC, 20005, US

(73) Assignees: Electronics and Telecommunications Research Institute, Daejeon-si (KR); Korea Advanced Institute of Science and Technology, Daejeon-si (KR)

(21) Appl. No.: 12/776,875

(22) Filed: May 10, 2010

(30) Foreign Application Priority Data
May 11, 2009 (KR) 10-2009-0040819
Nov. 30, 2009 (KR) 10-2009-0116983

(51) Int. Cl. G06F 1/12

(52) U.S. Cl. 713/400

(57) ABSTRACT

A timestamping apparatus and method are provided. The timestamping apparatus implements timestamping on a synchronization message at a physical layer when the synchronization message is transmitted to the physical layer. At an application layer of the timestamping apparatus, a bit stream including a start indicator bit informing a start of a pseudo random number sequence, the pseudo random number sequence, and an end indicator bit informing an end of the pseudo random number sequence is generated to check whether or not a message received from the physical layer is the synchronization message, and is inserted as signature information of the synchronization message. At the physical layer of the timestamping apparatus, the signature information included in the synchronization message is detected, and timestamping information is generated when the signature information is detected.

### CROSS-REFERENCE TO RELATED APPLICATION

This application claims the benefit under 35 U.S.C. §119(a) of Korean Patent Application Nos. 10-2009-0040819, filed on May 11, 2009, and 10-2009-0116983, filed on Nov. 30, 2009, the entire disclosures of which are incorporated herein by reference for all purposes.

### BACKGROUND

1. Field

The following description relates to network technology, and more particularly, to time synchronization technology.

2. Description of the Related Art

To equalize time information between terminals interconnected through a network, a time synchronizing process is required. For the time synchronizing process, there are various methods, such as institute of electrical and electronics engineers (IEEE) 1588 or network time protocol (NTP), of transferring timing information using a timestamp.

For example, IEEE 1588 is a standard time transfer protocol that enables accurate time synchronization between network terminals. IEEE 1588 performs time synchronization using a standard time difference between two terminals and a transfer delay time generated when a packet is transferred between the two terminals. However, in a timestamping method performed at existing medium access control (MAC) layer or an existing upper layer, uncertainties such as delay, jitter, etc. may occur at each layer. For this reason, the accuracy of a timestamp value is lowered.

### SUMMARY

The following description relates to an apparatus and method for providing an accurate timestamping point of time at a physical layer using a pseudo random number sequence.

Further, the following description relates to an apparatus and method for reducing a probability of incorrectly detecting a pseudo random number sequence.

According to an exemplary aspect, there is provided a timestamping apparatus, which includes a signature information generator, a signature information allocator, a signature information verifier, and a timestamping implementer. The signature information generator generates signature information including a start indicator bit informing a start of a pseudo random number sequence, the pseudo random number sequence, and an end indicator bit informing an end of the pseudo random number sequence. The signature information allocator allocates the signature information to a synchronization message. The signature information verifier detects the signature information included in the synchronization message at a physical layer. The timestamping implementer generates timestamping information when the signature information is detected.

According to another exemplary aspect, there is provided a timestamping apparatus receiving a synchronization message, which includes a signature information verifier and a timestamping implementer. When the message is received, the signature information verifier detects whether or not signature information including a start indicator bit informing a start of a pseudo random number sequence, the pseudo random number sequence, and an end indicator bit informing an end of the pseudo random number sequence is included in the message. The timestamping implementer generates timestamping information about the synchronization message when the signature information is detected.

According to still another exemplary aspect, there is provided a timestamping apparatus, which includes all the components of the timestamping apparatus according to an exemplary aspect and the timestamping apparatus receiving a synchronization message according to another exemplary aspect.

According to yet another exemplary aspect, there is provided a timestamping method, which includes: generating signature information including a start indicator bit informing a start of a pseudo random number sequence, the pseudo random number sequence, and an end indicator bit informing an end of the pseudo random number sequence; allocating the signature information to a synchronization message; detecting the signature information included in the synchronization message at a physical layer; and generating timestamping information when the signature information is detected.

According to yet another exemplary aspect, there is provided a timestamping method, which includes: receiving a message from another terminal; detecting signature information to check whether or not the signature information including a start indicator bit informing a start of a pseudo random number sequence, the pseudo random number sequence, and an end indicator bit informing an end of the pseudo random number sequence is included in the message; and determining the message as a synchronization message and generating timestamping information about the synchronization message when the signature information is detected.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 illustrates the configuration of a timestamping system for time synchronization according to an exemplary embodiment of the present invention.

FIG. 2 illustrates the hierarchical structure of a timestamping apparatus according to an exemplary embodiment of the present invention.

FIG. 3 illustrates the configuration of a transmitter in a timestamping apparatus according to an exemplary embodiment of the present invention.

FIG. 4 illustrates an example of a signature information format.

FIG. 5 illustrates the configuration of a receiver in a timestamping apparatus according to an exemplary embodiment of the present invention.

FIG. 6 illustrates an example of a method of generating a pseudo random number sequence according to an exemplary embodiment of the present invention.

FIG. 7 illustrates an example of a method of generating a start indicator bit informing the start of a pseudo random number sequence.

FIG. 8 illustrates an example of a method of generating an end indicator bit informing the end of a pseudo random number sequence.

FIG. 9 illustrates an example of a method of detecting a pseudo random binary sequence (PRBS).

FIG. 10 is a flowchart illustrating a timestamping method for implementing timestamping at a physical layer according to an exemplary embodiment of the present invention.

FIG. 11 is a flowchart illustrating a timestamping method for performing synchronization in response to reception of a synchronization message according to an exemplary embodiment of the present invention.

FIG. 12 illustrates an example of applying a timestamping method according to an exemplary embodiment of the present invention to an institute of electrical and electronics engineers (IEEE) 802.3ba model.

FIG. 13 illustrates an example of applying a timestamping method according to an exemplary embodiment of the present invention to an IEEE 802.3 model.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

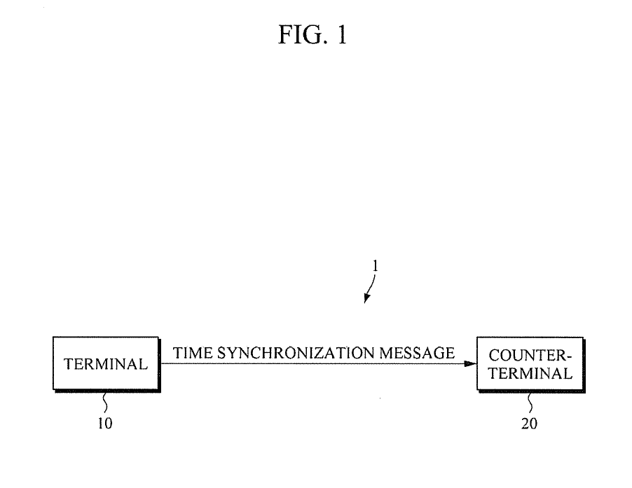

FIG. 1 illustrates the configuration of a timestamping system for time synchronization according to an exemplary embodiment of the present invention.

Referring to FIG. 1, the timestamping system includes a terminal 10 and a counter-terminal 20 connected to a network. Here, the terminal 10 and the counter-terminal 20 synchronize with each other. In an example embodiment, time synchronization between terminals may be realized in Ethernet, more particularly a high-speed Ethernet network such as 40 G or 100 G Ethernet, but it is not limited to this configuration.

According to an exemplary embodiment of the present invention, institute of electrical and electronics engineers (IEEE) 1588 may be used for time synchronization between terminals. IEEE 1588 is a standard for a precision clock synchronization protocol for networked measurement and control systems, and is used for a protocol for equalizing time information between terminals interconnected through a network. IEEE 1588 is designed to achieve time synchronization using a reference time difference between two terminals and a transfer delay time generated when a packet is transferred between the two terminals.

There are two terminals within a network, one of which is a master terminal providing a reference clock, and the other is a slave terminal matching its own time information with that of to the master terminal to perform synchronization. For example, in FIG. 1, the master terminal is designated by a reference number 10, and the slave terminal is designated by a reference number 20. The mater and slave terminals may be plural in number.

Here, the mater and slave terminals may synchronize with each other using a Sync message, a Follow-up message, a Delay Request message, a Delay Response message, a Propagation Delay Request message, a Propagation Delay Response message and so on.

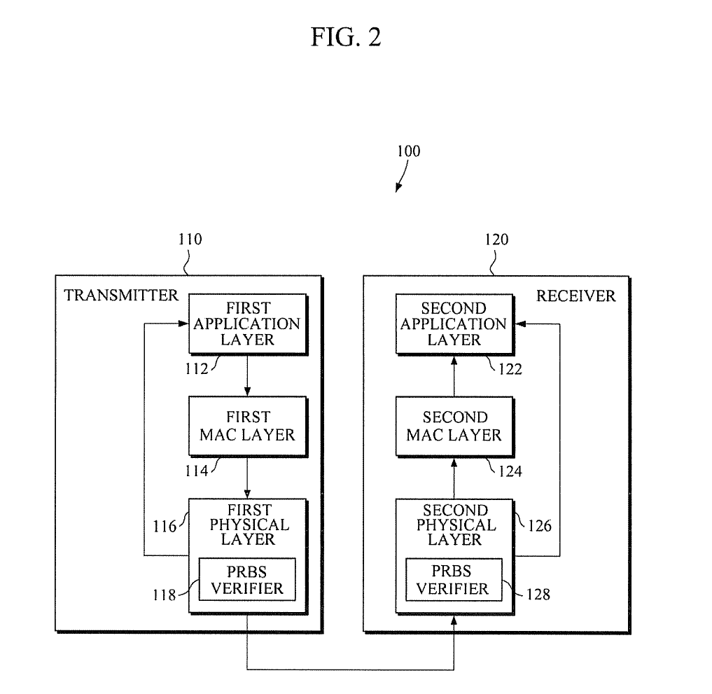

FIG. 2 illustrates the hierarchical structure of a timestamping apparatus according to an exemplary embodiment of the present invention.

Referring to FIG. 2, a timestamping apparatus 100 according to an exemplary embodiment of the present invention may include a transmitter 110 and a receiver 120. Here, the timestamping apparatus 100 may be the terminal 10 or the counter-terminal 20 described in FIG. 1, and may include one or both of the transmitter 110 and the receiver 120.

Referring to FIG. 2 again, the timestamping apparatus 100 includes application layers 112 and 122, media access control (MAC) layers 114 and 124, and physical layers 116 and 126.

The timestamping apparatus 100 determines implementation of timestamping at the physical layer to provide accurate timestamping. In one exemplary embodiment, as a timestamping location (or time) is based on the physical layer, timestamping accuracy is improved. As an example, when timestamping is implemented at a layer higher than the MAC layer, it is impossible to obtain a precise result value of timestamping due to jitter, central processing unit (CPU) access time, etc. on software. As another example, when timestamping is implemented within the MAC layer, it is impossible to obtain a precise result value of timestamping due to delay or jitter caused by retransmission, medium access, or pause control.

However, as the timestamping location is determined to be the lowermost layer, i.e. the physical layer, it is possible to solve the problem occurring when timestamping is implemented at the layer other than the physical layer as mentioned above, and to improve the timestamping accuracy.

First, an operation of implementing the timestamping will be described with reference to the hierarchical structure of the transmitter 110. Signature information may be generated and allocated at the first application layer 112 or the first MAC layer 114. Generation and allocation of the signature information at the first application layer 112 will be described, and then generation and allocation of the signature information at the first MAC layer 114 will be described.

For time synchronization between the terminals, the first application layer 112 may allocate signature information capable of identifying a synchronization message to a message to be transmitted to the counter-terminal and transmit the signature information to the first physical layer 116 via the first MAC layer 114. In this process, the first MAC layer 114 receives a packet from the first application layer 112 and transmits the packet to the first physical layer 116.

The longer the length of a bit stream corresponding to the signature information, the lower a probability of a detector incorrectly detecting the bit stream indicating timestamping information. For example, a 64-bit signature bit stream may be used, and the length of the signature bit stream may be varied depending on systems.

Here, the signature information may be allocated to a Type, Length, Value (TLV) field, which indicates information about a type, length and value of the synchronization message. The TLV field is a field that may be selectively allocated to the end of the synchronization message such as the IEEE 1588 message. Thus, the TLV field may have a format in which a predefined type is allocated to its Type sub-field, a length of its following value is allocated to its Length sub-field, and data that a user wants is allocated to its Value sub-field. As the signature information is allocated to the selective TLV field of the synchronization message, it is possible to accurately implement timestamping without modifying an existing network configuration.

Meanwhile, according to an exemplary embodiment, the signature information includes a sequence identifier for discriminating the synchronization message, a pseudo random number sequence, and indicator bits informing a start and end of the pseudo random number sequence.

The pseudo random number sequence is not a completely random bit stream, but a bit stream having a pattern that is artificially made random. The pseudo random number sequence may be generated using a Mersenne twister, a prime polynomial, or so on. As an example, the pseudo random number sequence may be generated through a linear feedback shift register (LFSR) having a linear feedback. Here, the pseudo random number sequence has been described as being a pseudo random binary sequence (PRBS). However, another random number sequence may be used.

The LFSR is a circuit in which its values are shifted by one according to the period of clock, and simultaneously a result of exclusive-or (XOR) calculation of preset tab values is applied as an input value of the shift register. For this reason, it is possible to provide simple timestamping through a pseudo random number sequence algorithm using this LFSR.

As described above, the signature information may be generated and allocated at the first MAC layer 114 as well as at the first application layer 112. At the first MAC layer 114, a start frame delimiter is generated to inform the start of a frame. The start frame delimiter is typically configured of a bit stream having a total of 8 bytes, of which 7 bytes are repeated with 1 and 0, and 1 byte is repeated with only 1. The frame start is indicated using this special bit stream.

In an exemplary embodiment of the present invention, when the signature information is generated and allocated at the first MAC layer 114, a bit stream for discriminating the synchronization message configured of the sequence identifier and the pseudo random number sequence, and the indicator bits that inform the start and end of the pseudo random number sequence may be used as the start frame delimiter. As the bit stream for discriminating the synchronization message is inserted as the start frame delimiter of the first MAC layer 114, it is possible to detect the frame start, discriminate the synchronization message, and easily detect the sequence identifier.

The first physical layer 116 receives the bit stream from the first MAC layer 114, and verifies whether or not the received bit stream includes the signature information using a PRBS verifier 118. In detail, all bits passing through the first physical layer 116 are sequentially stored in a register of the PRBS verifier 118. It is checked whether the bits correspond to a pseudo random number sequence by XOR of a result value of the LFSR and a bit following the bit stored in the register. If the detected bits correspond to the pseudo random number sequence, the PRBS verifier 118 may detect 0 as its result value. Otherwise, the PRBS verifier 118 may detect 1 as its result value. Alternatively, the PRBS verifier 118 may be configured in such a manner that if the detected bits correspond to the pseudo random number sequence, the PRBS verifier 118 may detect 1 as its result value, and that if the detected bits do not correspond to the pseudo random number sequence, the PRBS verifier 118 may detect 0 as its result value. It should be interpreted that the present invention is not limited to the aforementioned exemplary embodiment but it includes a variety of exemplary embodiments.

Next, the first physical layer 116 determines the received bit stream after being verified to be the synchronization message, and instructs a timestamping implementer (not shown) to implement timestamping, and the timestamping implementer may transmit a command to store timestamping information and a sequence identifier in a register (not shown). Here, it is possible to verify the pseudo random number sequence through the PRBS verifier 118 that inversely uses the prime polynomial at the first physical layer 116.

The first application layer 112 restores the sequence identifier using the sequence received from the PRBS verifier 118 with reference to a mapping table. The first application layer 112 may perform a post verification function of checking whether or not the restored sequence identifier is its own recently transmitted sequence identifier. This post verification function can remarkably reduce errors that may occur at a pseudo random number sequence detector. Here, the post verification function has been described as being performed at the first application layer 112. Alternatively, a pre-verification function may be performed at another layers. An additional synchronization message such as a Follow-up message may be generated at the first application layer 112 or at another layer using the timestamping information stored in the register of the first physical layer 116.

Next, a process of detecting timestamping information, which may be included in a message received from a counter-terminal, to perform synchronization will be described with reference to the hierarchical structure of the receiver 130.

The second MAC layer 124 receives a packet from the second physical layer 126, and transmits the received packet to the second application layer 122. The second physical layer 126 receives a message from a counter-terminal. At the second physical layer 126, it is possible to verify whether or not signature information is included in the received message using a PRBS verifier 128. In detail, all bits passing through the second physical layer 126 are sequentially stored in a register of the PRBS verifier 128. It is checked whether the bits correspond to a pseudo random number sequence by XOR of a result value of the LFSR and a bit behind the bit stored in the register. If the detected bits correspond to the pseudo random number sequence, the PRBS verifier 128 may detect 0 as its result value. Otherwise, the PRBS verifier 128 may detect 1 as its result value.

As a result of the verification, if the received message is determined as a synchronization message including timestampting information, the timestamping information included in the synchronization message is stored in a second register (not shown). This register may be located at the physical layer 126 or at another layer. It is possible to read the timestamping information stored in the second register at the layer that performs a timestamping function.

To perform synchronization, a time t1 at which a first synchronization (Sync) message is transmitted by a transmission terminal and a time t2 at which the first Sync message is received by a reception terminal are required. The transmitted time t1 of the first Sync message may be transmitted through a Follow-up message. When arriving at the physical layer of the reception terminal, the first Sync message is determined as a synchronization message through a signature information detector in a physical layer. At this time, the detected time is stored in a register as the received time t2.

A Delay Request message and a Delay Response message may be processed in the same principle. In detail, the reception terminal (slave terminal) sends a Delay Request message to the second physical layer 126 to send signature information to the transmission terminal (master terminal) similar to when sending the Sync message. At the second physical layer 126, timestamping is implemented on detecting the signature information to obtain a time t3. The master terminal receiving the Delay Request message discriminates the signature information to implement timestamping at the first physical layer 116, inserts a timestamping time t4 into a Relay Response message, and sends the Relay Response message to the slave terminal again. The slave terminal receiving the Relay Response message may extract the time t4 from the Relay Response message, and obtain an offset time and a propagation time. This configuration capable of detecting the signature information to implement timestamping at the physical layer may be similarly applied to other Sync messages than the aforementioned Sync, Follow-up, Delay Request, and Delay Response messages.

Meanwhile, a function of detecting the signature information is inserted into the physical layers 112 and 122. Signature information detection circuits, i.e. PRBS verifiers 118 and 128, for detecting the signature information are different in configuration from each other depending on detailed locations in the physical layers 112 and 122. The PRBS verifier 118 may be configured to include a component other than the PRBS detector that detects the signature information, wherein the component is required to detect the signature information.

If the signature information detection function is inserted into the front end of a scrambler (not shown) in the first physical layer 112 of the transmitter 110, the PRBS verifier 118 is simply configured of a PRBS detector. In contrast, if the signature information detection function is inserted into a rear end of the scrambler in the first physical layer 112 of the transmitter 110, the PRBS verifier 118 is configured of a descrambler circuit (not shown) and a PRBS detector. A bit stream scrambled by the scrambler of the first physical layer 112 is descrambled by the descrambler of the PRBS verifier 118, and the descrambled bit stream is detected by the PRBS detector.

If the signature information detection function is inserted into the front end of a descrambler (not shown) in the second physical layer 122 of the receiver 120, the PRBS verifier 128 is simply configured of the descrambler circuit (not shown) and a PRBS detector. In contrast, if the signature information detection function is inserted into a rear end of the descrambler in the second physical layer 122 of the receiver 120, the PRBS verifier 128 is simply configured of a PRBS detector.

When the signature information detection function is inserted behind the scrambler/descrambler, it is possible to expect a more accurate timestamp value. However, the PRBS verifiers 118 and 128 require the descrambler as an additional circuit.

In the case of a low-speed network, data may be subjected to serial data transmission in the physical layers 112 and 122. In the case of a high-speed network, data may be subjected to parallel data transmission in the physical layers 112 and 122. For this reason, the PRBS verifiers 118 and 128 may use a simple serial detector or a parallel detector according to a data transmission method in the physical layers 112 and 122 of the network. As the parallel detector, the descrambler and the PRBS detector may be used, which are well known to those skilled in the art and process data in parallel.

A timestamping apparatus and method according to an exemplary embodiment will be described in detail below with reference to a hierarchical structure illustrated in FIG. 2.

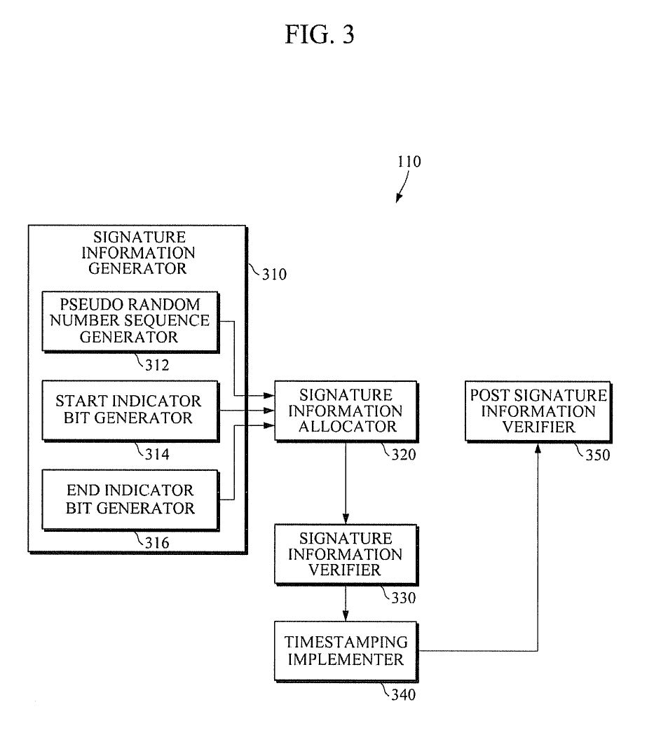

FIG. 3 illustrates the configuration of a transmitter in a timestamping apparatus according to an exemplary embodiment of the present invention.

Referring to FIG. 3, the transmitter 110 according to an exemplary embodiment includes a signature information generator 310, a signature information allocator 320, a signature information verifier 330, and a timestamping implementer 340. The transmitter 110 may further include a post signature information verifier 350. The signature information generator 310, the signature information allocator 320, and the post signature information verifier 350 may be located at the first application layer 112 or the MAC layer 114, and the signature information verifier 330 and the timestamping implementer 340 may be located at the first physical layer 116.

The signature information generator 310 generates a pseudo random number sequence, a start indicator bit informing the start of the pseudo random number sequence, and an end indicator bit informing the end of the pseudo random number sequence.

The signature information generator 310 may include a pseudo random number sequence generator 312, a start indicator bit generator 314, and an end indicator bit generator 316.

The pseudo random number sequence generator 312 may insert preset input bits into a prime polynomial, thereby generating the pseudo random number sequence. To generate the pseudo random number sequence, the pseudo random number sequence generator 312 may insert the input bits into the prime polynomial with reference to a table in which the input bits are mapped to values of the sequence identifier of a time synchronization message. The input bits may constitute an arbitrary 17-bit sequence other than a sequence filled with only 0 bits. Here, the sequence identifier may be a sequence identifier within a received packet, but any type will do if it can be identified. A mapping table between the input bit and the sequence identifier or a pseudo random number mapping function is shared with all application layers of the reception terminal.

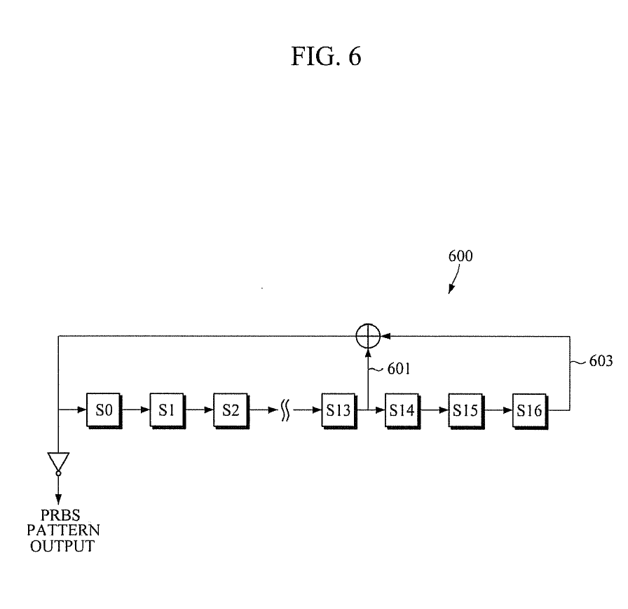

As an example of using the prime polynomial, a shift register may be used for simple realization. The shift register may be a 17-bit LFSR. For example, to generate a synchronization message on which information about a synchronization message serial or specific number is mounted, the pseudo random number sequence generator 312 may generate a 45-bit pseudo random number sequence using the 17-bit LFSR. The generation of the pseudo random number sequence of the LFSR will be described below in detail with reference to FIG. 6.

The start indicator bit generator 314 generates a start indicator bit informing the start of the pseudo random number sequence, and the end indicator bit generator 316 generates an end indicator bit informing the end of the pseudo random number sequence. The start and end indicator bits may be made through a 17-bit sequence mapped to the sequence identifier, and then are allocated to detect an accurate timestamp at the timestamping implementer 340. The start and end indicator bit generators 314 and 316 may generate the start and end indicator bits such that the start and end indicator bits are detected not to be the pseudo random number sequence when detecting the pseudo random number sequence at the physical layer.

As an example, the start indicator bit generator 314 may generate the start indicator bits using a 0-th tab and a tab increasing by one from a tab used when the pseudo random number sequence is generated using the LFSR. The end indicator bit generator 316 may generate the end indicator bits using a value obtained by inverting a bit that is output behind the last bit of the pseudo random number sequence when the pseudo random number sequence is generated using the LFSR.

The signature information allocator 320 allocates signature information having the pseudo random number sequence to a synchronization message. The signature information allocator 320 may allocate the signature information to a TLV field, which indicates information about a type, length and value of the synchronization message. For example, a bit stream corresponding to the signature information may be allocated to a Value sub-field of the TLV field of the synchronization message such as an IEEE 1588 message. Further, the signature information allocator 320 may allocate the signature information having the pseudo random number sequence to a start frame delimiter of the first MAC layer 114.

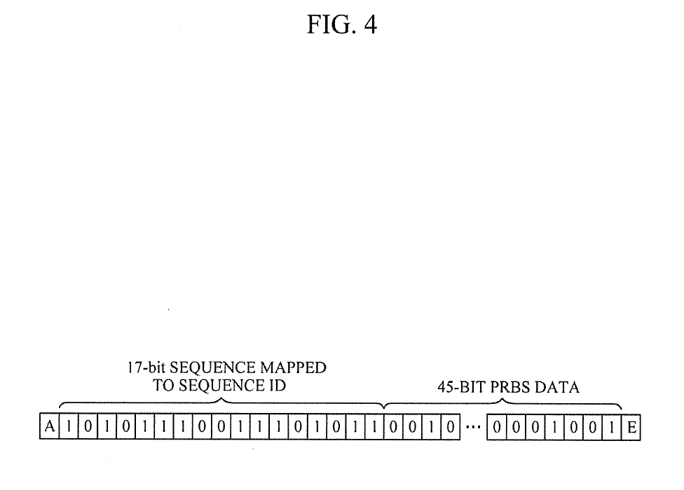

FIG. 4 illustrates an example of a signature information format.

Referring to FIG. 4, a 64-bit signature bit stream is constituted of a start indicator bit A of 1 bit indicating the start of the pseudo random number sequence, 17 input bits, a 45-bit pseudo random number sequence for the input bits, and an end indicator bit E of 1 bit indicating the end of the pseudo random number sequence.

The foremost bit A of 1 bit is obtained by the following 17-bit sequence, and is allocated to indicate the start of the pseudo random number sequence. The start indicator bit A can indicate the start of the pseudo random number sequence, because a value of the start indicator bit A is not detected as the pseudo random number sequence but the following 45-bit pseudo random number sequence is detected as the pseudo random number sequence when the signature information passes through the signature information verifier 330 detecting the pseudo random number sequence.

The 17-bit sequence following the start indicator bit A is a sequence that is mapped to the sequence identifier at the application layer, and is set to an initial value of the LFSR for generating the start indicator bit and the pseudo random number sequence. The 45-bit sequence following the 17-bit sequence belongs to the pseudo random number sequence, and is generated depending on the preceding 17-bit sequence. Further, the end indicator bit E of 1 bit indicating the end of the pseudo random number sequence is inserted next to the 45-bit pseudo random number sequence.

Referring to FIG. 3 again, the signature information verifier 330 verifies whether or not the bit stream received from an upper layer includes the signature information at the physical layer. If it is checked that the bit stream includes the signature information, the timestamping implementer 340 determines the bit stream to be the synchronization message, and implements timestamping.

The signature information verifier 330 may verify the pseudo random number sequence using the LFSR. The shift register used in the signature information verifier 330 must use the same coefficient as a pseudo random number sequence generator.

When the signature information sequence illustrated in FIG. 4 passes through the signature information verifier 330 configured of the LFSR, the 17-bit sequence located next to the start indicator bit is sequentially stored in the LFSR, and then the following other 45 bits are sequentially inserted into the LFSR starting from the first bit. Thus, when verifying the pseudo random number sequence, the signature information verifier 330 may determine the received bit stream to be the synchronization message when “1” bit is output as a result value once, “0” bit is continuously output 45 times in succession, and then “1” bit is output due to the end indicator bit.

In this case, the signature information verifier 330 determines the input bit stream to be the IEEE 1588 message, and transmits a timestamping command and values of the sequence identifier to the timestamping implementer 340. Then, the timestamping implementer 340 implements timestamping, and stores the timestamped value and the sequence identifier values in a register (not shown). The sequence identifier values may be stored in the LFSR for simply detecting the PRBS using connection of an additional LFSR.

Meanwhile, in consideration of the case where a detection error may occur at the signature information verifier 330, the transmitter 110 may include the post signature information verifier 350 that verifies the pseudo random number sequence again to reduce the detection error. The post signature information verifier 350 may verify whether or not the pseudo random number sequence received from the signature information verifier 330 is the pseudo random number sequence that has recently been transmitted to the physical layer 116 at the first application layer 112 or the MAC layer 114. Thereby, it is possible to remarkably reduce a probability of the detection error.

For example, the post signature information verifier 350 receives the 17 input bits mapped to the sequence identifier values from the timestamping implementer 340. The post signature information verifier 350 compares the sequence transmitted from the timestamping implementer 340 with the recently transmitted sequence. If both of the sequences are identical to each other, the post signature information verifier 350 may search for the sequence identifier with reference to a pre-stored table or function, and transmit a message including timestamping information to another terminal using the searched sequence identifier. For example, the searched sequence identifier may be used by a Follow-up message, for instance a Follow-up message of IEEE 1588, informing a timestamp value of a transmission synchronization packet. Since the Follow-up message includes the sequence identifier associated with the first synchronization message, it is compared with the sequence identifier read out of the register. Only when the corresponding value exists, the post signature information verifier 350 may read the timestamp value, and transmit the Follow-up message including the timestamp value.

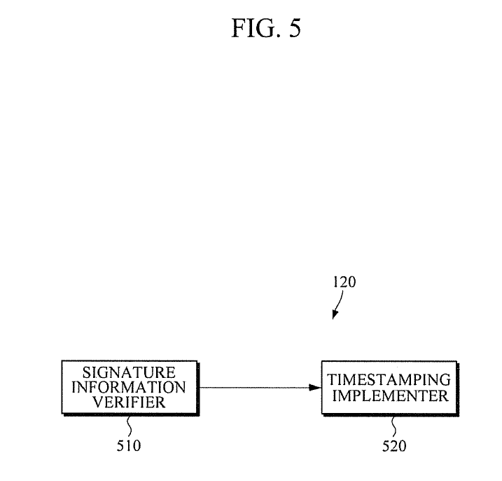

FIG. 5 illustrates the configuration of a receiver according to an exemplary embodiment of the present invention.

Referring to FIG. 5, the receiver 120 includes a signature information verifier 510, and a timestamping implementer 520. The signature information verifier 510 is located at the second physical layer 126.

When a message is received from the counter-terminal, the signature information verifier 510 verifies whether or not the signature information defined according to an exemplary embodiment is included in the received message at the second physical layer 126, and identifies whether or not the received message is the synchronization message including the timestamping information.

Here, the signature information verifier 510 may realize a pseudo random number sequence detector adapting a prime polynomial to verify the pseudo random number sequence. For example, the bit stream illustrated in FIG. 4 passes through the second physical layer 126 to be stored in a preset register (not shown).

The signature information verifier 510 verifies the signature information using the same method as the signature information verifier 330 of the transmitter 110. As a result of the detection, when “1” bit is output, “0” bit is output 45 times in succession, and then “1” bit is output again, the signature information may be identified as the synchronization message. Here, when the signature information according to an exemplary information is verified, the signature information verifier 510 transmits values stored in the register to the timestamping implementer 520.

The timestamping implementer 520 may identify the sequence identifier corresponding to the input bits included in the signature information stored in the register using the mapping table shared with the first application layer 112 or the MAC layer 114 of the transmitter 110, determine a time at which the synchronization message is verified at the second physical layer 126 to be a synchronization message arrival time, and generate timestamping information abut the synchronization message arrival time.

FIG. 6 illustrates an example of a method of generating a pseudo random number sequence.

Referring to FIG. 6, a 17-bit LFSR 600 generates a pseudo random number sequence according to an exemplary embodiment. The 17-bit LFSR 600 sequentially receives a 17-bit sequence from S0 to S16 mapped to the sequence identifier at the application layer, extracts a 45-bit pseudo random number sequence, and outputs it as a result value (PRBS pattern). Here, to generate serial numbers as many as possible, a 14-th bit 601 and a 17-th bit 603 may be set as tabs.

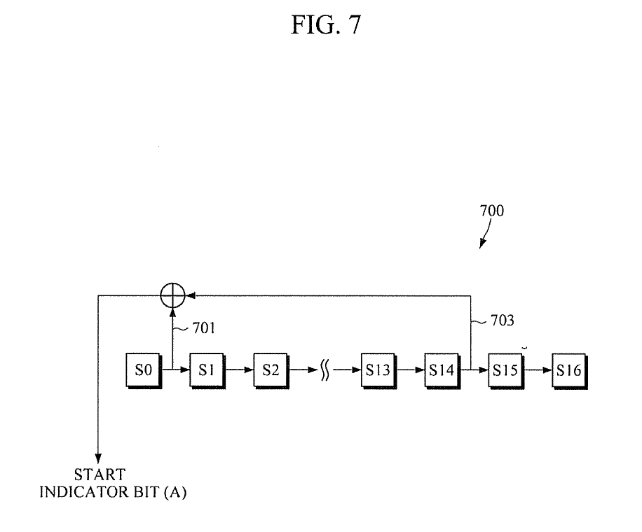

FIG. 7 illustrates an example of a method of generating a start indicator bit informing the to start of a pseudo random number sequence.

Referring to FIG. 7, the start indicator bit is generated to intentionally have an error bit during pseudo random number sequence detection to inform the start of the pseudo random number sequence. To this end, the start indicator bit is required for the foremost bit of an entire signature information sequence, that is, just ahead of the 17-bit sequence mapped to the sequence identifier.

The start indicator bit (or additional bit) may be obtained using an LFSR 700 having the same configuration as the LFSR 600 used to generate the pseudo random number sequence. However, assuming that tabs of the LFSR 600 used to generate the pseudo random number sequence are indicated by T₀, T₁, . . . , T_{N}, tabs of the LFSR 700 for generating the pseudo random number sequence use 0, T₀+1, T₁+1, . . . , T_{N}+1. In detail, the tabs of the LFSR for the start indicator bit have higher orders than the tabs for generating the pseudo random number sequence by one, and a first register S0 must always be used as the tab. If the tab of T_{N}+1 does not exist, that is, if the number of used LFSRs is smaller than T_{N}+1, the tab of T_{N}+1 is not used.

Register values must be previously input to generate the start indicator bit in such a manner that a 17-bit sequence mapped to the sequence identifier is sequentially input into S16 to S0 like when the pseudo random number sequence is generated for the first time. Further, a result of calculating XOR between the tabs is inverted at the LFSR 600 illustrated in FIG. 6. However, such a result of calculating XOR between the tabs may not be inverted at the LFSR 700 used in the start indicator bit generator 314.

As illustrated in FIG. 7, if the tabs of the 17-bit LFSR 600 are 14-th and 17-th tabs to generate the pseudo random number sequence, the 17-bit LFSR 700 equal to the 17-bit LFSR 600 is used and its tabs must be a 0-th tab 701, a 15-th tab 703, and an 18-th tab to generate the start indicator bit. Here, since the 18-th tab does not exist in the 17-bit LFSR 700, the start indicator bit is configured to be generated using the 17-bit LFSR 700 using the 0-th tab 701 and the 15-th tab 703.

When the normally generated pseudo random number sequence bits are detected as 0 through the detector, the start indicator bit is detected as 1 through a calculating process of the pseudo random number sequence bits and the start indicator bit during pseudo random number sequence detection. For this reason, it is possible to know the start of the pseudo random number sequence.

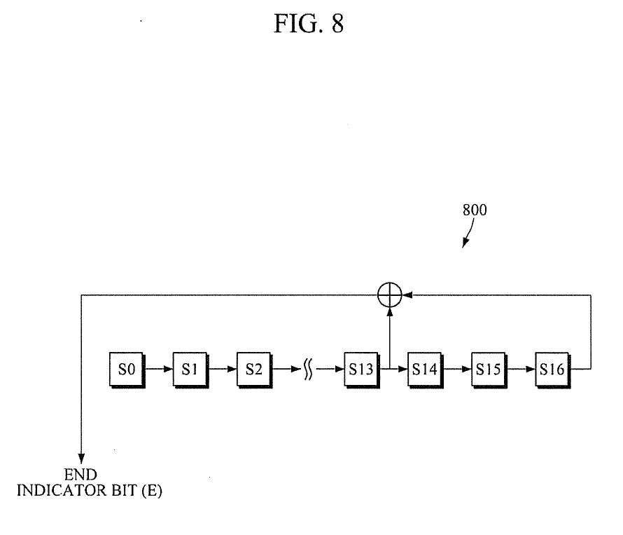

FIG. 8 illustrates an example of a method of generating an end indicator bit informing the end of a pseudo random number sequence.

As illustrated in FIG. 8, the end indicator bit may be generated as a 1-bit end indicator bit of the pseudo random number sequence using a 17-bit LFSR 800 that generates a result of attaching a NOT signal to a result value of generating the pseudo random number sequence.

When a sequence generated by the normal pseudo random number sequence generator is detected as 0 through the detector, the end indicator bit is detected as 1 by inverting an output value of the pseudo random number sequence. Through this detection, a user can recognize the end of the pseudo random number sequence.

The end indicator bit E informing that the pseudo random number sequence is ended is allocated to the next of the 45-bit pseudo random number sequence in the signature information format as illustrated in FIG. 4. The end indicator bit E may be obtained by inverting the 46-th bit generated by the pseudo random number sequence generator. Since the PRBS end indicator bit E will be detected not to be a pseudo random number during pseudo random number sequence detection, the end indicator bit E can indicate the last of the pseudo random number sequence.

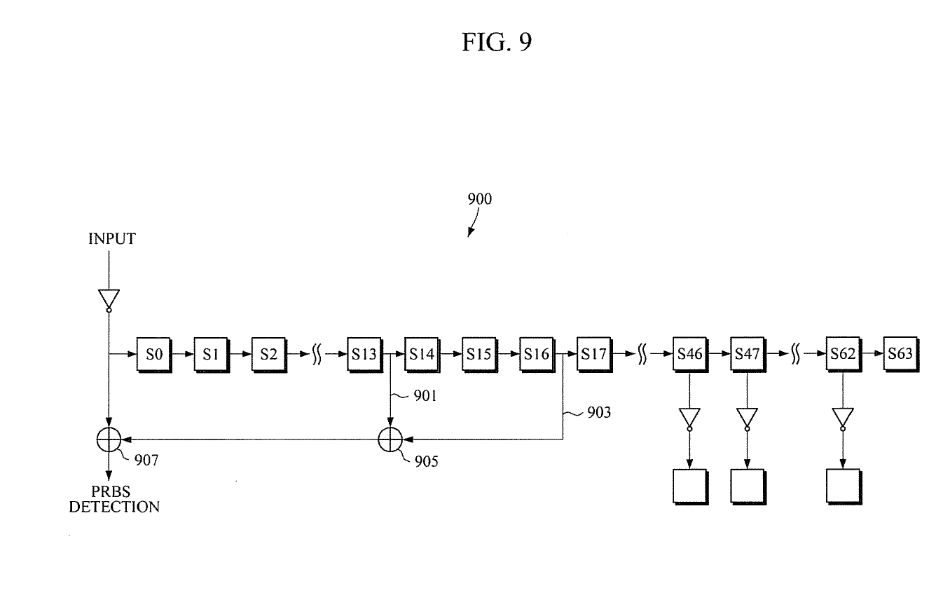

FIG. 9 illustrates an example of a method of detecting a PRBS.

Referring to FIG. 9, the signature information verifier 330 including the 17-bit LFSR according to an exemplary embodiment detects the pseudo random number sequence of a bit stream passing through the first physical layer 116. Since the pseudo random number sequence is generated through the 17-bit LFSR, the 17-bit LFSR is also used to detect the pseudo random number sequence. To maximize the number of serial numbers matching the pseudo random number sequence, XOR 905 is calculated using a 14-th tab 901 and a 17-th tab 903 generating a maximum pattern.

Here, the 17-bit LFSR calculates XOR 907 of an input value received from the first application layer 112 and a result value of the 17-bit LFSR. The internal values of the 17-bit LFSR 900 are shifted by one bit whenever the input value is received, and are subjected to automatic XOR-calculation.

When the 64-bit signature information sequence generated at the first application layer 112 or the MAC layer 114 passes through the signature information verifier 330, the 17-bit sequence is sequentially stored in the 17-bit LFSR, and the other 47 bits are sequentially allocated to the detector as input values starting from the first bit. As a result of detecting the input values, 1 may be detected once, 0 may be detected 45 times in succession, and then 1 may be detected once. Thus, it is possible to identify whether or not the signature information is the synchronization message for which the timestamping is required by detecting the pseudo random number sequence.

When the bit stream is verified as the synchronization message at the signature information verifier 330, and thus the timestamping is required for the bit stream, the sequence identifier is transmitted to the upper layer. As one example of performing this function, it is possible to use a method of inserting a total of 64 registers into the signature information verifier 330 as illustrated in FIG. 9. In addition to 17 registers for detecting the PRBS, 47 registers are additionally inserted behind the 17 registers, so that it is possible to store the bits that have already been passed. For example, when 1 is detected once, 0 is detected 45 times in succession, and then 1 is detected once, values obtained by inverting values from the 46-the register to the 62-th register, that is values of the sequence identifier, may be extracted and transmitted to the upper layer. Here, the number of registers may be changed by the number and characteristics of used bits.

Meanwhile, even when the bit stream received at the first physical layer 116 is not the synchronization message, it may satisfy requirements of the signature information, and thus an error that the bits are detected once for 1, 45 times in succession for 0, and then once for 1 from the LFSR 900 may occur. In this case, when receiving the pseudo random number sequence from the post signature information verifier 350 of the first application layer 112 or the MAC layer 114, the post signature information verifier 350 compares the received pseudo random number sequence with the sequence recently transmitted to the signature information verifier 330 of the first physical layer 116. Through this comparison function, it is possible to remarkably reduce a probability of the detection error.

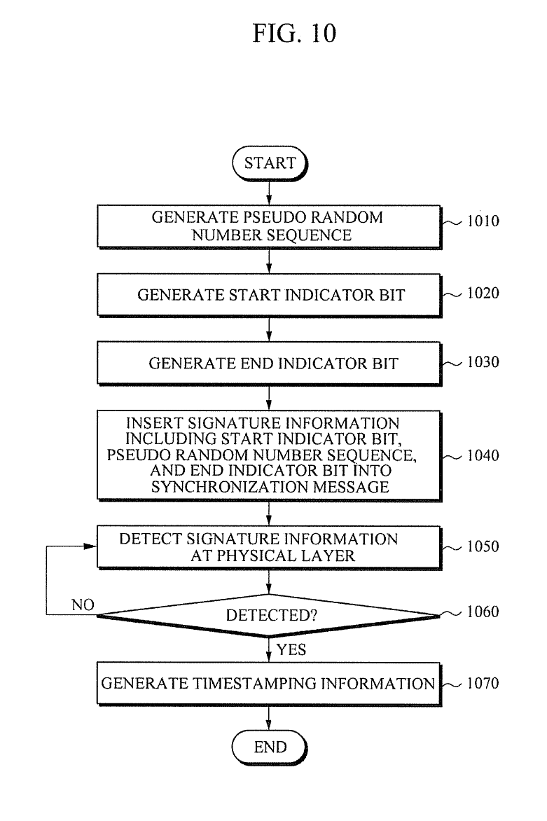

FIG. 10 is a flowchart illustrating a timestamping method for implementing timestamping at a physical layer according to an exemplary embodiment of the present invention.

It is assumed that a mapping table between an arbitrary 17-bit sequence other than a sequence filled with only 0 bits and a sequence identifier is generated and shared with all nodes.

The signature information generator 310 generates a pseudo random number sequence using the 17-bit sequence mapped to the sequence identifier (operation 1010), a start indicator bit informing a start of the pseudo random number sequence (operation 1020), and an end indicator bit informing an end of the pseudo random number sequence (operation 1030).

The signature information allocator 320 inserts a bit stream including the start indicator bit, the pseudo random number sequence, and the end indicator bit into a synchronization message as signature information (operation 1040).

The signature information verifier 330 detects the pseudo random number sequence from the bit stream transmitted from the upper layer (operation 1050). When the signature information, for instance illustrated in FIG. 5, is detected once for 1, 45 times in succession for 0, and then once for 1 (operation 1060) as a result value, the signature information verifier 330 located at the first physical layer 116 regards it as an IEEE 1588 synchronization message, and the timestamping implementer 340 generates timestamping information (operation 1070).

The bit stream and the timestamping information are transmitted to the upper layer, for instance the first application layer 112 or the MAC layer 114, and the post signature information verifier 350 checks whether or not the sequence transmitted from the first physical layer 116 is identical to the sequence recently transmitted from the first application layer 112 or the MAC layer 114. If it is checked that the sequence transmitted from the first physical layer 116 is identical to the sequence recently transmitted from the first application layer 112 or the MAC layer 114, the post signature information verifier 350 may search for a sequence identifier with reference to a pre-stored table, generate an additional synchronization message (e.g. a Follow-up message) including the timestamping information using the searched sequence identifier, and transmit it to another terminal.

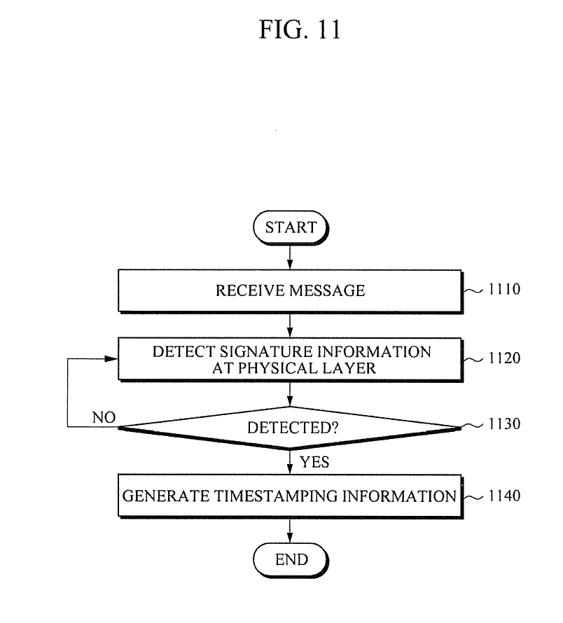

FIG. 11 is a flowchart illustrating a timestamping method for performing synchronization in response to reception of a synchronization message according to an exemplary embodiment of the present invention.

When a message is received (operation 1110), the signature information verifier 510 detects signature information using a PRBS detector, for instance an LFSR, of the transmission terminal at the second physical layer 126 to check whether or not the received message is a synchronization message including timestamping information (operation 1120).

When the signature information having a preset format is detected, for instance, once for 1, 45 times in succession for 0, and once for 1 (operation 1130), the signature information verifier 510 regards it as the synchronization message, and generates timestamping information (operation 1140). Further, when the received message is a Follow-up message, it is possible to know the sequence identifier using a mapping table shared with the application layer or the MAC layer of the transmission terminal, it may be determined to which synchronization message the timestamping information is allocated, and the timestamping information about the corresponding sequence identifier may be extracted.

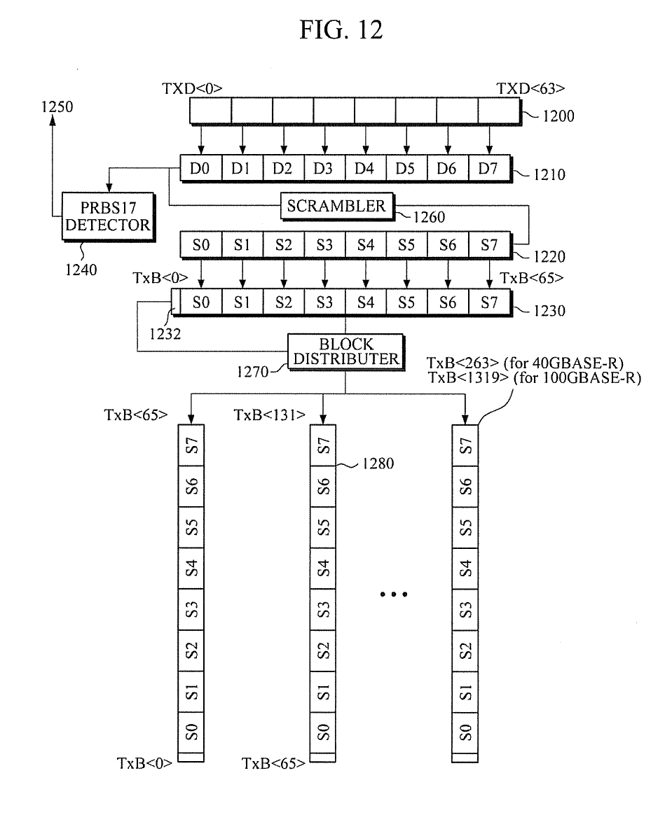

FIG. 12 illustrates an example of applying a timestamping method according to an exemplary embodiment of the present invention to an IEEE 802.3ba model.

Here, the timestamping process will be described taking an IEEE 802.3ba structure using 40 G/100 G Ethernet by way of example. Referring to FIG. 12, the timestamping apparatus 100 according to an exemplary embodiment encodes a bit stream block 1200 received from an upper layer using an encoder to generate an encoded block 1210 at a physical layer.

Next, the timestamping apparatus 100 causes the encoded block 1210 to pass through a PRBS17 detector 1240, thereby verifying the pseudo random number sequence of a bit stream. Here, the PRBS17 detector 1240 corresponds to the signature information verifier 330 of FIG. 3.

At this time, the PRBS17 detector 1240 may be interposed between an encoder and a scrambler at a physical coding sub-layer inside the physical layer. In this Ethernet model, when the bit stream passes through the scrambler 1260, bits are deformed. For this reason, it is hard to detect a 45-bit pseudo random number sequence having serial number information. Thus, this model may dispose the PRBS17 detector 1240 between the encoder block 1210 and the scrambler block 1260, but it is not limited to this configuration. In other words, as illustrated in FIG. 12, the PRBS17 detector 1240 may be separately located, or realized by connection between other functional blocks.

Furthermore, the timestamping apparatus 100 may transmit the pseudo random number sequence detected by the PRBS17 detector 1240 of the physical layer to the application layer 1250, and verify again whether or not the pseudo random number sequence is identical to that transmitted recently by the application layer 1250. As described above, the verification of the pseudo random number sequence may be performed at another layer.

Next, the timestamping apparatus 100 scrambles the encoded block 1210 through the scrambler 1260 to generate a scrambled block 1220. A synchronization header 1232 is allocated to the scrambled block 1220, and thereby a transmission block 1230 is generated. The synchronization header 1232 may be configured of “01” or “10” for synchronization. Meanwhile, a block distributor 1270 of the physical layer distributes the transmission block 1230 to lanes. At this time, a time synchronization packet is transmitted to a counter-terminal that is a target for the time synchronization.

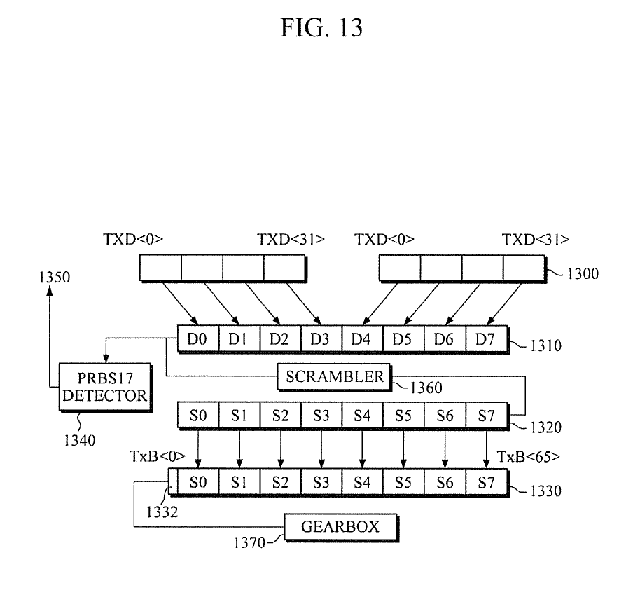

FIG. 13 is a reference view for explaining a timestamping process according to another exemplary embodiment of the present invention. Here, the timestamping process will be described taking an IEEE 802.3 structure using 1 G/10 G Ethernet by way of example.

Referring to FIG. 13, the timestamping apparatus 100 according to an exemplary embodiment encodes a bit stream block 1300 received from an upper layer using an encoder to generate an encoded block 1310 at a physical layer.

Next, the timestamping apparatus 100 causes the encoded block 1310 to pass through a PRBS17 detector 1340, thereby verifying the pseudo random number sequence of a bit stream. Here, the PRBS17 detector 1340 may be interposed between an encoder and a scrambler at a physical coding sub-layer inside the physical layer. In this Ethernet model, when the bit stream passes through the scrambler 1360, bits are deformed. For this reason, it is hard to detect a 32-bit pseudo random number sequence having serial number information. Thus, this model may dispose the PRBS17 detector 1340 between the encoder block 1310 and the scrambler block 1360.

Furthermore, the timestamping apparatus 100 may transmit the pseudo random number sequence detected by the PRBS17 detector 1340 of the physical layer to the upper layer 1350, and verify again whether or not the pseudo random number sequence is identical to that transmitted recently by the application layer 1350.

Next, the timestamping apparatus 100 scrambles the encoded block 1310 through the scrambler 1360 to generate a scrambled block 1320. At this time, a synchronization header 1332 is allocated to the scrambled block 1320, and thereby a transmission block 1330 is generated. Next, the transmission block 1330 is transmitted to a gearbox 1370. As described above, it can be found that the timestamping can be applied to the IEEE 802.3ba model as well as the IEEE 802.3 model. That is, it can be found that the timestamping can be easily applied without sharply modifying existing various network structures.

The exemplary embodiments of the present invention can also be embodied as computer-readable codes on a computer-readable recording medium. Codes and code segments constituting the programs can be easily deduced by computer programmers skilled in the art. The computer-readable recording medium is any data storage device that can store data which can be thereafter read by a computer system. Examples of the computer-readable recording medium include read-only memories (ROMs), random-access memories (RAMs), CD-ROMs, magnetic tapes, floppy disks, and optical data storage devices. The computer-readable recording medium can also be distributed over network connected computer systems so that the computer-readable code is stored and executed in a distributed fashion.

According to the physical layer-based timestamping method using the synchronization message to which the signature information is allocated, it is possible to reduce uncertainties such as delay and jitter that may occur in the timestamping method implemented at upper layers such as existing MAC and application layers, and provide timestamping having high accuracy.

Further, it is possible to provide a simple, accurate timestamping method by inserting and detecting the signature information into and from the selective TLV field of IEEE 1588 without sharply modifying an existing configuration of Ethernet. In addition, to provide uniqueness of the signature information, a method of allocating arbitrary indicator bits to the bits just ahead of and behind the pseudo random number sequence is used, and a sufficient number of pseudo random number sequences are used, so that it is possible to remarkably reduce a probability of mistaking typical data for a timestamp sequence.

Further, the synchronization message can be identified by the signature information of the TLV field rather than information added at each layer such as a MAC type, a user datagram protocol (UDP) port, etc. within a packet, so that the synchronization message can be generated and processed without restrictions of layers such as IP, UDP, transmission control protocol (TCP), and so on.

In addition, an additional circuit is minimized without separately modifying an existing network structure, so that it is possible to be applied to an existing model without a trouble.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A timestamping apparatus, comprising:
a signature information generator generating signature information including a start indicator bit informing a start of a pseudo random number sequence, the pseudo random number sequence, and an end indicator bit informing an end of the pseudo random number sequence;
a signature information allocator allocating the signature information to a synchronization message;
a signature information verifier detecting the signature information included in the to synchronization message at a physical layer; and
a timestamping implementer generating timestamping information when the signature information is detected.

2. The timestamping apparatus of claim 1, wherein the signature information allocator allocates the signature information to a Type, Length, Value (TLV) field of the synchronization message.

3. The timestamping apparatus of claim 1, wherein the signature information allocator allocates the signature information to a start frame delimiter of a medium access control (MAC) layer.

4. The timestamping apparatus of claim 1, wherein the signature information generator generates the start and end indicator bits such that the start and end indicator bits are detected not to be the pseudo random number sequence when detecting the pseudo random number sequence at the physical layer.

5. The timestamping apparatus of claim 1, wherein the signature information generator generates the start indicator bit using a 0-th tab and a tab increasing by one from a tab used when the pseudo random number sequence is generated using a linear feedback shift register (LFSR).

6. The timestamping apparatus of claim 1, wherein the signature information generator generates the end indicator bit using a value obtained by inverting a bit output behind a last bit of the pseudo random number sequence when the pseudo random number sequence is generated using an LFSR.

7. The timestamping apparatus of claim 1, wherein the signature information verifier performs exclusive-or (XOR) calculation on an LFSR, and detects the signature information using a value of the XOR calculation and an input value of the LFSR.

8. The timestamping apparatus of claim 1, further comprising a post signature information verifier verifying whether or not the signature information includes input bits previously transmitted from an upper layer to the physical layer.

9. The timestamping apparatus of claim 1, wherein the signature information allocator generates an additional synchronization message including the timestamping information implemented on the synchronization message by the timestamping implementer, and the additional synchronization message is transmitted to another terminal.

10. A timestamping apparatus receiving a message, comprising:
a signature information verifier detecting whether or not, when the message is received, signature information including a start indicator bit informing a start of a pseudo random number sequence, the pseudo random number sequence, and an end indicator bit informing an end of the pseudo random number sequence is included in the message; and
a timestamping implementer generating timestamping information about the message when the signature information is detected.

11. The timestamping apparatus of claim 10, wherein the start and end indicator bits are set to be detected not to be the pseudo random number sequence during pseudo random number sequence detection.

12. The timestamping apparatus of claim 10, wherein the start indicator bit is generated using a 0-th tab and a tab increasing by one from a tab used when the pseudo random number sequence is generated using a linear feedback shift register (LFSR).

13. The timestamping apparatus of claim 10, wherein the end indicator bit is generated using a value obtained by inverting a bit output behind a last bit of the pseudo random number sequence when the pseudo random number sequence is generated using an LFSR.

14. A timestamping apparatus, comprising:
a signature information generator generating signature information including a start indicator bit informing a start of a pseudo random number sequence, the pseudo random number sequence, and an end indicator bit informing an end of the pseudo random number sequence;
a signature information allocator allocating the signature information to a synchronization message;
a first signature info' illation verifier detecting the signature information included in the synchronization message at a physical layer;
a first timestamping implementer generating timestamping information when the signature information is detected;
a signature information verifier verifying whether or not, when a message is received from another terminal, signature information including a start indicator bit informing a start of a pseudo random number sequence, the pseudo random number sequence, and an end indicator bit informing an end of the pseudo random number sequence is included in the message; and
a second timestamping implementer generating timestamping information about the message when it is verified that the signature information is included.

15. A timestamping method, comprising:
generating signature information including a start indicator bit informing a start of a pseudo random number sequence, the pseudo random number sequence, and an end indicator bit informing an end of the pseudo random number sequence;
allocating the signature information to a synchronization message;
detecting the signature information included in the synchronization message at a physical layer; and
generating timestamping information when the signature information is detected.

16. The timestamping method of claim 15, wherein the allocating of the signature information to a synchronization message includes inserting the signature information to a Type, Length, Value (TLV) field of the synchronization message.

17. The timestamping method of claim 15, wherein the start and end indicator bits are generated to be detected not to be the pseudo random number sequence during pseudo random number sequence detection.

18. The timestamping method of claim 15, wherein the start indicator bit is generated using a 0-th tab and a tab increasing by one from a tab used when the pseudo random number sequence is generated using a linear feedback shift register (LFSR), and
the end indicator bit is generated using a value obtained by inverting a bit output behind a last bit of the pseudo random number sequence when the pseudo random number sequence is generated using an LFSR.

19. The timestamping method of claim 15, further comprising:
generating an additional synchronization message including the timestamping information determined at the physical layer with respect to the synchronization message; and
transmitting the additional synchronization message to another terminal.

20. A timestamping method, comprising:
receiving a message from another terminal;
detecting signature information to check whether or not the signature information including a start indicator bit informing a start of a pseudo random number sequence, the pseudo random number sequence, and an end indicator bit informing an end of the pseudo random number sequence is included in the message; and
generating timestamping information about the message when the signature information is detected.
